(19) United States
(12) Patent Application Publication
(10) Pub. No.: US 2024/0291419 A1
(43) Pub. Date: Aug. 29, 2024

(54) Tandem Photovoltaic and Thermophotovoltaic Cell Assemblies for Converting Solar Energy to Electricity and Methods and Systems Therefor

(71) Applicant: Michael S. Hulen, Waltham, MA (US)

(72) Inventor: Michael S. Hulen, Waltham, MA (US)

(21) Appl. No.: 18/408,441

(22) Filed: Jan. 9, 2024

Related U.S. Application Data
(60) Provisional application No. 63/437,769, filed on Jan. 9, 2023.

(51) Int. Cl. H02S 10/30; H02S 40/22

(52) U.S. Cl. CPC H02S 10/30; H02S 40/22

(57) ABSTRACT

The solar energy conversion assembly, system and method of the present invention combines a primary traditional solar photovoltaic (PV) cell with a secondary thermophotovoltaic (TPV) cell located behind or near the primary cell in a tandem design where incoming solar light is concentrated on to the PV cell and the PV cell emits infrared radiation to the TPV cell.

### CROSS-REFERENCE TO RELATED APPLICATION

The present patent application claims priority from U.S. Provisional Patent Application Ser. No. 63/437,769 filed Jan. 9, 2023, the entirety of which is incorporated by reference herein.

### BACKGROUND OF THE INVENTION

### Field of the Invention

The present invention relates to conversion of solar energy to electric energy and, more particularly, to increasing the efficiency of such conversion by use of a photovoltaic (PV) and thermophotovoltaic (TPV) cell assembly thus reducing greenhouse gas emissions and mitigating climate change.

### Brief Discussion of the Related Art

There are various solar concentrating systems that heat water or a working fluid that are in the category of concentrated solar power (CSP). Solar power towers and parabolic trough solar collectors fit into this group. Both use steam to drive Rankin Cycle equipment with a turbine to produce electricity. Some systems combine a photovoltaic module with a fluid based thermal collector. The disadvantage of such systems is that they use a thermoelectric cell which requires a large temperature gradient (a cool side and a hot side) to make use of the “Seebeck” effect to generate current. The thermoelectric device is mounted against the PV cell to get heat. The circulating fluid, which can be water, creates the cool side of the thermoelectric module.

Another system proposes a concentrated solar apparatus that can focus the light in varying proportions onto either a PV cell or a separate thermal collector. The thermal collector can use a working fluid to remove and store the heat. These systems have the disadvantages of involving pumped fluid solution which is substantially larger and less efficient and of not using cutting edge technologies.

Thermophotovoltaic (TPV) cells convert the photons of mid and long wavelength infrared light, that is emitted heat, into electrons for electricity. In recent years, breakthroughs at MIT, ASU, NREL and Fraunhofer Institute have produced more efficient TPV cells. The cells, like triple junction cells, combine exotic materials in the infrared radiation designs, such as GaSb, GaIn, GaAs, SiC, InP and Ge. PV/TPV cell designs in the past have included a stack of codings and, for the most part, use a mix of materials in a stacked, hybrid design on a substrate to achieve electrical conversion of photons at visible as well as infrared radiation wavelengths. Similar to the triple junction codings on a germanium PCV substrate, the PV/TPV designs are simply layers of coatings on each other and do not form a PV cell separate from the TPV cell. Attempts to stack mini coatings atop one another have disadvantages from technical, production, yield and performance issues related to differences in thermal expansion coefficients of the materials, thermal stress, adhesion and delamination which can lead to device failure. Additionally, the conversion efficiency of sunlight to electrical energy is a maximum of 43% and cannot achieve the combined efficiency of separate PV and TPV cells or modules.

### SUMMARY OF THE INVENTION

The tandem solar energy assembly of the present invention leverages both the visible and short wavelength spectrums of light with a photovoltaic cell; as well as the longer wave infrared spectrum of light with a thermophotovoltaic cell that receives infrared radiation from the hot photovoltaic cell. High temperatures are required to get high infrared radiation emission from the photovoltaic cell and the present invention includes a concentrating optic and a photovoltaic material that can withstand the high temperatures. Silicon (Si) as a photovoltaic material is used at lower concentrations and lower temperatures, whereas a material such as Ge or GaAs is preferred to operate at high temperatures and not degrade rapidly. A material such as a Germanium based triple junction cell, the type typically used for space-based solar energy applications, can also be used.

The present invention uses a TPV cell in combination with a highly efficient photovoltaic cell made of a material able to withstand high temperatures and not degrade under the high temperatures in combination with a concentrator to intensify incoming solar radiation.

Briefly, the system and method of the present invention utilize a concentrating optic to focus and concentrate a wide area of incoming solar radiation onto a tandem cell including a PV cell made of a material with high conversion efficiency that will not decay rapidly under intense radiation and high temperatures, such as, but not limited to, a triple-junction Germanium cell. The PV cell receives concentrated light which creates heat and the heated PV cell has a back surface with a highly emissive layer that focuses infrared radiation onto a thermophotovoltaic cell. The back surface of the photovoltaic cell can have micro-structures or nano-structures to increase the emissivity of the surface, cool the photovoltaic cell, concentrate or direct emission of infrared radiation or selectively emit wavelength to match optimal functioning wavelength of the thermophotovoltaic cell. With the tandem cell arrangement, solar radiation is converted to electric current at high efficiency first by the photovoltaic cell and then by the TPV cell.

Briefly, the present invention relates to a tandem photovoltaic and thermophotovoltaic cell assembly for converting solar energy to electricity, the assembly including a photovoltaic cell having a top surface exposed to concentrated sunlight and a back emissive surface for emitting infrared radiation and a thermophotovoltaic cell receiving the infrared radiation and made of a material capable of converting the infrared radiation to electrons. A system for conversion of solar energy to electricity according to the present invention includes a photovoltaic cell, a thermophotovoltaic cell and an optical system disposed in a housing where the optical system receives solar radiation to concentrate the solar radiation onto the top surface of the photovoltaic cell and the thermophotovoltaic cell receives infrared radiation from the photovoltaic cell to convert the infrared radiation to electric current. Also, in accordance with the present invention, the invention involves a method of mitigating climate change by increasing the efficiency of the conversion of solar energy to electricity by concentrating solar radiation onto a photovoltaic cell that produces electricity and infrared radiation, converting the infrared radiation to electric current with the use of a thermophotovoltaic cell and combining the light-created electric current and the heat-created electric current.

One advantage of the present invention is that the tandem photovoltaic and thermophotovoltaic assembly is a solid-state device with direct solar to electric conversion.

The solar energy conversion assembly, system and method of the present invention combines a primary traditional solar photovoltaic (PV) cell with a secondary thermophotovoltaic (TPV) cell located behind or near the primary cell in a tandem design where incoming solar light is concentrated on to the PV cell and the PV cell emits infrared radiation to the TPV cell.

The PV cell converts the visible spectrum and shorter wavelengths of light to electrons (electricity), while the TPV cell converts to electrons the infrared spectrum of light it receives as emission from the PV cell. Solar energy systems that use lenses or mirrors to concentrate the incoming solar radiation can get very hot. Temperatures can be over 2000 c. The use of a PV material such as a Germanium (Ge) based or Gallium Arsenide (GaAs) based multijunction cell is best to withstand the high temperatures without degradation.

Other aspects and advantages of the present invention will become apparent from the following description of the preferred embodiments taken in conjunction with the accompanying drawings.

### BRIEF DESCRIPTION OF THE DRAWINGS

FIG. 1 is a schematic illustration of an embodiment of the present invention with the housing for the cell assembly broken and showing radiation from a sun, incident upon an optic which focuses the light onto a photovoltaic module which converts the sunlight radiation photons to electrons (electric current) and also becomes hot from concentrated light such that the backside of the PV module, due to the high temperature, emits infrared radiation which impinges upon a thermal photovoltaic module that converts the infrared radiation two electrons, thus generating an electrical current.

FIG. 2 shows the PV and TPV cells held in the housing adjacent one another with reflective mirrors positioned in the housing to surround the gap between the cells so that any stray light from the PV cell is reflected on to the TPV cell. Reflective or mirrored surfaces can be on the inside walls of the housing which supports and aligns the components of the tandem cell assembly.

FIG. 3 is a schematic illustration of another embodiment of a tandem cell assembly according to the present invention that includes an infrared focusing lens behind the PV cell that concentrates the emitted infrared light permitting the TPV cell to be of a smaller size.

FIG. 4 illustrates the PV cell surface with a layer of a highly emissive material on the back surface to increase the emission of infrared radiation.

FIG. 5 illustrates the emissive layer on the surface of the PV cell having micro-structures to cool the cell, enhance the emission from the surface, to concentrate the light directed to the surface, and to tune the emitted wavelength of the light to the peak performance of the thermophotovoltaic cell.

FIG. 6 shows the tandem cell with the PV surface formed with anti-reflection nano-structures to facilitate capture of maximum levels of incoming solar radiation and also shows anti-reflection micro-structures on the TPV surface to capture maximum levels of infrared radiation emitted from the PV cell as well as reflection from the walls of the housing.

FIG. 6A is similar to FIG. 6 and shows the reflective cell walls being sloped or angled.

FIG. 7 shows an embodiment where infrared radiation is focused down an internally reflective light pipe to a thermal battery or an energy conversion device.

FIG. 8A shows a tandem cell assembly to be mounted in a panel along with multiple tandem cell assemblies as shown in FIG. 8B and FIG. 8C shows multiple panels mounted on a solar tracking platform.

FIG. 9 shows an embodiment where infrared radiation from the photovoltaic cell is focused down an internally reflective light pipe similar to the embodiment shown in FIG. 7 but without a thermophotovoltaic cell.

### DETAILED DESCRIPTION OF THE INVENTION

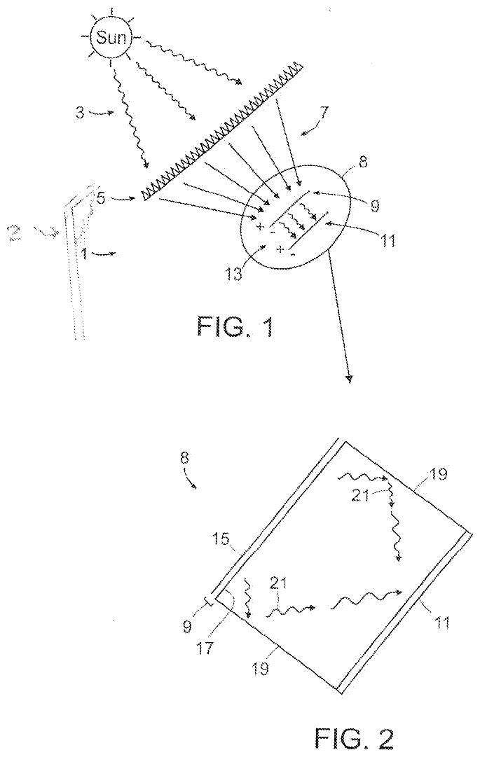

An embodiment of a tandem cell assembly 1 according to the present invention is shown in FIG. 1 in a housing 2 where the sun's radiation 3 is focused by a concentrating lens 5 into a concentrated beam of light 7 onto a Germanium multijunction photovoltaic cell 9. A Fresnel type of lens 5 is shown but the options for the concentrating optics (lenses and mirrors or combinations thereof) are not limited to Fresnel designs and, for example, can include, but are not limited to diamond turned optics, aspheric designs, Fresnel, linear Fresnel, parabolic designs, Winston concentrators, Cassegrain designs, and diffractive optics. The concentrated beam of the sun's rays make the PV cell very hot causing it to emit infrared radiation 13. The infrared radiation impinges on the thermophotovoltaic cell 11 which converts the infrared radiation to electrons forming electrical current that can be combined with electrical current produced by PV cell 9. The combination of the PV cell and the TPV cell is called the tandem cell 8. The apparatus with the focusing lens and tandem cell combined forms the tandem cell assembly 1. The tandem cell assembly can be a stand-alone unit and can also be an array of assemblies, optionally built into a panel with solar tracking capability.

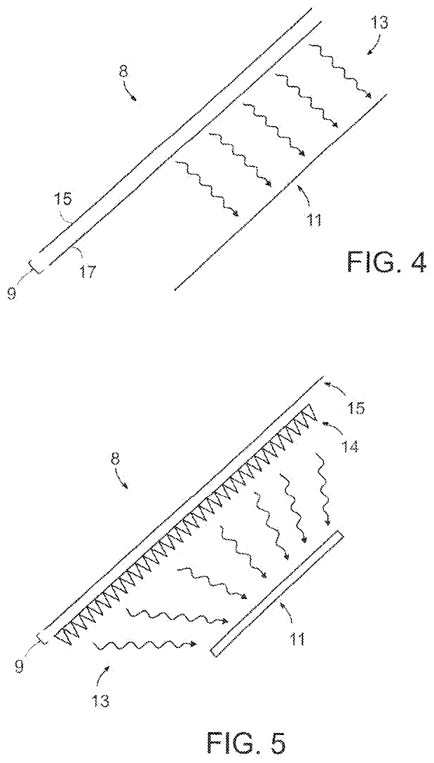

FIG. 2 shows the embodiment of the tandem cell 8. The PV cell 9 has a top material 15 preferably of, but not limited to, a germanium multijunction cell, which includes epitaxial coating layers to convert wavelengths of the visible spectrum of light to electrons; and a back layer 17 that is a highly emissive material such as, but not limited to, made of tungsten or a tungsten alloy, graphite, Silicon Carbide, Aluminum Oxide, or Quartz. The combined PV structure with the emissive layer 9 converts a broad spectrum of the visible and shorter wavelengths of light while emitting the heat as infrared radiation from the back emissive surface to the TPV cell 11. The walls of this tandem cell have reflective or mirrored surfaces 19 so stray light (off normal angle) can be directed to the TPV cell 11. If the PV cell is larger than the TPV cell, a trapezoidal design can be used wherein the reflective walls can be of a sloped, conical, or concentrating design as in FIG. 4.

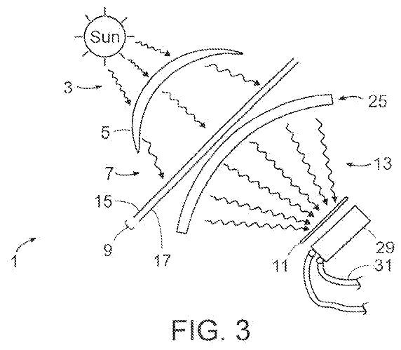

The embodiment of FIG. 3 shows the Tandem Cell Assembly 1 with an infrared optic 25 to focus the infrared radiation 13 emitted from the photovoltaic cell surface 17. The sun's radiation 3 is concentrated with a convex/concave optic 5 on to the PV cell 9; an infrared lens or optic 25 (lens, window, mirror or combination of transmissive and reflective optics) behind the PV cell concentrates the infrared radiation 13 onto a smaller TPV module 11. One advantage of concentrating the infrared radiation is that it increases the intensity of the infrared radiation light while also decreasing the spot size of the beam allowing for a smaller TPV cell chip. TPV cells require very sophisticated semiconductor processing equipment and techniques to produce them. Therefore, TPV cells are expensive. Including infrared radiation concentrating optics 25 reduces the size of a TPV chip 11 needed and reduces costs. An infrared optic of Zinc Selenide (ZnSe) or Clear Zinc Sulfide (MS-ZnS) will perform well because these infrared radiation material types have broad transmission across the infrared spectrum and do not degrade at high temperatures. In addition, the infrared radiation optical element 25 can be coated to selectively transmit a specific wavelength that is tuned to the peak performance of the TPV cell 11. If there is excess heat coming off the TPV cell 11, an energy conversion device (ECD) 29 can be added to improve efficiency of the tandem cell assembly. The ECD can be one of several options including but not limited to another TPV module, a fluid-based cooling system, or a thermoelectric generator. Adding the ECD, along with the PV and TPV cells will add efficiency to the Tandem Cell assembly. Adding the ECD also has the advantage of cooling and stabilizing the temperature of the TPV cell 11, giving it better operational efficiencies. Fluid transport hoses 31 can be used in the case that the ECD is a fluid-based system. Additional ECD units can be added to the bottom of the assembly if more heat energy is available.

The embodiment of FIG. 4 shows the tandem cell 8 with the PV cell 9 where the top layer of the PV material 15 has a backing layer of a highly emissive material 17. The infrared radiation 13 from the photovoltaic emissive surface 17 impinges on the TPV cell 11.

Inasmuch as the present invention is subject to many variations, modifications and changes in detail, it is intended that all subject matter discussed above or shown in the accompanying drawings be interpreted as illustrative only and not be taken in a limiting sense.

In the embodiment of FIG. 5, the tandem cell 8 with the PV cell 9 has a backing layer of a highly emissive material with surface-relief micro-structures 14 formed into the emissive surface to increase the infrared radiation emissivity, cool the photovoltaic cell 9 and to steer/focus the beam on to the TPV cell 11. As shown, the rays 13 emitted from the micro-structures 14 are focused to the center, thus concentrating the beam into a smaller spot size on the TPV cell 11. The TPV cell is smaller than the PV cell which reduces cost. The micro-structures can also be designed to emit a radiation wavelength that is tuned to the peak performance of the TPV cell 11.

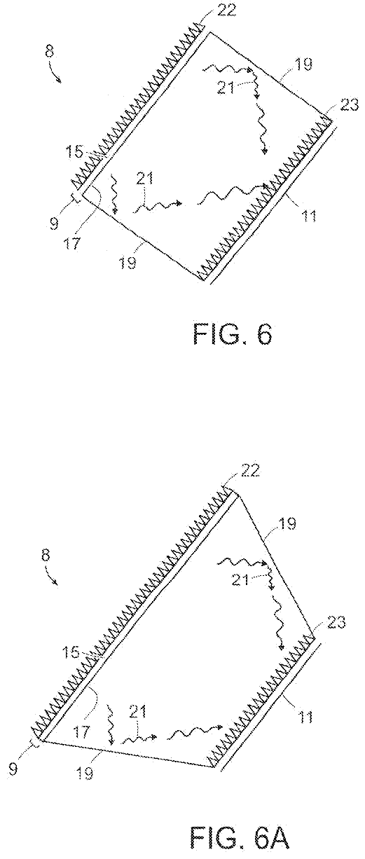

FIG. 6 shows the tandem cell with the PV top surface formed 9 with anti-reflection nano-structures 22 to help capture maximum levels of incoming solar radiation. Also depicted are anti-reflection micro-structures on the TPV surface 23 to capture maximum levels of infrared radiation emitted from the PV cell. The height and period (spacing) of these conical shaped surface-relief structures are relative to the wavelength of light they are capturing and are trying to prevent from reflecting. For the incoming solar radiation at visible and shorter wavelengths the structures are called “nano-structures” as measured in nanometers. For the longer infrared wavelengths of light, the larger, wider spaced cones are called “micro-structures” as measured in micrometers. In the field of optics and photonics, thin-film coating layers have traditionally been used for anti-reflection (AR) surfaces. Advantages of the surface-relief anti-refection surfaces discussed above include high performance and a longer lifetime in high radiation environments than traditional AR thin film coatings; and, the surface-relief structures survive considerably longer than thin-film AR coatings and, the surface-relief structures survive considerably longer than thin-film AR coatings through intense thermal cycling as would be the environment of the tandem cell assembly. The cell has reflective walls 19 to direct stray, off normal angled light 21 onto the TPV surface.

The embodiment of FIG. 6A is similar to FIG. 6 but depicts the reflective cell walls as sloped 19 to help concentrate the stray light on to the TPV cell 11 and to properly mount a larger PV cell 9 to a smaller TPV cell 11.

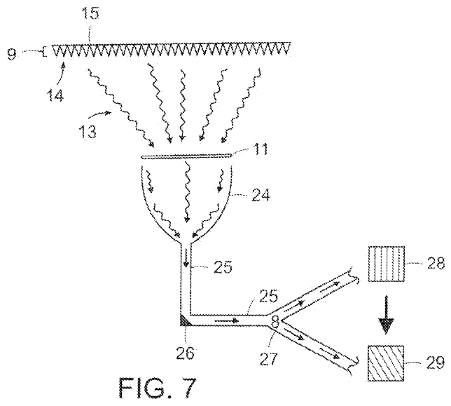

The embodiment of FIG. 7 shows an internally reflective light pipe 25 through which the infrared radiation from the back of the TPV cell is channeled to another location where it can be directed in proportions by a Light Valve 27 to a thermal battery 28 or to an energy conversion device 29. In this case, a Winston concentrator type of mirror 24 is used to focus the light into the pipe, but other concentrator optical designs using lenses, mirrors or combinations thereof can be used to focus the radiation into the pipe. The thermal battery 28 can store the infrared radiation energy as heat and be released as desired/needed to the ECD 29 which can be helpful for electrical-grid peak load management. Optics within the pipe such as the mirror 26 can be used to guide the beam particularly around turns, bends, or corners.

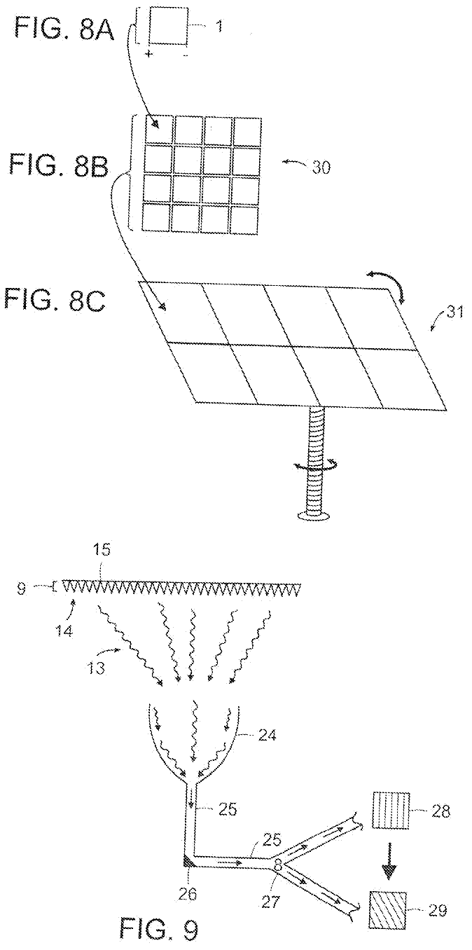

FIG. 8A shows a tandem cell assembly 1, which can be mounted as part of a larger solar panel 30 that is made up of multiple tandem cell assemblies as in FIG. 8B. FIG. 8C shows the solar panel of FIG. 8B mounted with multiple such solar panels as part of a solar tracking platform/system.

The embodiment shown in FIG. 9 is similar to the embodiment shown in FIG. 7 with the exception that the infrared radiation from the photovoltaic cell 9 is directed to the light pipe that is received by the light pipe directly from the photovoltaic cell. The internally reflective light pipe 25 receives infrared radiation directly from the back of the PV cell 9 to channel the radiation to another location where it can be directed in proportion by a light valve 27 to a thermal battery 28 or to an energy conversion device 29. The TPV cell can be located at the end of the light pipe as an energy conversion device. A Winston concentrator type of mirror 24 focuses the radiation into the pipe. The thermal battery can store the infrared energy as heat and be released as desired or needed to the energy conversion device. Accordingly, this embodiment is particularly useful for electrical-grid peak load management. Optics within the pipe are used to guide the beam within the pipe. The embodiment of FIG. 9 has economic advantages in that individual TPV cells are not required to be mounted at each tandem cell assembly that is infrared radiation from multiple assemblies can be gathered and converted to electricity at a single location.

Other aspects and advantages of the present invention will become apparent from the following description of the preferred embodiments taken in conjunction with the accompanying drawings wherein like parts in each of the several figures are identified by the same reference characters.

### DETAILED DESCRIPTION OF THE INVENTION

An embodiment of a tandem cell assembly 1 according to the present invention is shown in FIG. 1 in a housing 2 where the sun's radiation 3 is focused by a concentrating lens 5 into a concentrated beam of light 7 onto a Germanium multijunction photovoltaic cell 9. A Fresnel type of lens 5 is shown but the options for the concentrating optics (lenses and mirrors or combinations thereof) are not limited to Fresnel designs and, for example, can include, but are not limited to diamond turned optics, aspheric designs, Fresnel, linear Fresnel, parabolic designs, Winston concentrators, Cassegrain designs, and diffractive optics. The concentrated beam of the sun's rays make the PV cell very hot causing it to emit infrared radiation 13. The infrared radiation impinges on the thermophotovoltaic cell 11 which converts the infrared radiation to electrons forming electrical current that can be combined with electrical current produced by PV cell 9. The combination of the PV cell and the TPV cell is forms the tandem cell 8. The apparatus with the focusing lens and tandem cell combined forms the tandem cell assembly 1. The tandem cell assembly can be a stand-alone unit and can also be an array of assemblies, optionally built into a panel with solar tracking capability.

FIG. 2 shows an embodiment of the tandem cell 8. The PV cell 9 has a top material 15 preferably of, but not limited to, a germanium multijunction cell, which includes epitaxial coating layers to convert wavelengths of the visible spectrum of light to electrons; and a back layer 17 that is a highly emissive material such as, but not limited to, made of tungsten or a tungsten alloy, graphite, Silicon Carbide, Aluminum Oxide, or Quartz. The combined PV structure with the emissive layer 9 converts a broad spectrum of the visible and shorter wavelengths of light while emitting the heat as infrared radiation from the back emissive surface to the TPV cell 11. The walls of this tandem cell have reflective or mirrored surfaces 19 so stray light (off normal angle) can be directed to the TPV cell 11. If the PV cell is larger than the TPV cell, a trapezoidal design can be used wherein the reflective walls can be of a sloped, conical, or concentrating design as in FIG. 4.

The embodiment of FIG. 3 shows the Tandem Cell Assembly 1 with an infrared optic 25 to focus the infrared radiation 13 emitted from the photovoltaic cell surface 17. The sun's radiation 3 is concentrated with a convex/concave optic 5 on to the PV cell 9; an infrared lens or optic 25 (lens, window, mirror or combination of transmissive and reflective optics) behind the PV cell concentrates the infrared radiation 13 onto a smaller TPV module 11. One advantage of concentrating the infrared radiation is that it increases the intensity of the infrared radiation light while also decreasing the spot size of the beam allowing for a smaller TPV cell chip. TPV cells require very sophisticated semiconductor processing equipment and techniques to produce them. Therefore, TPV cells are expensive. Including infrared radiation concentrating optics 25 reduces the size of a TPV chip 11 needed and reduces costs. An infrared optic of Zinc Selenide (ZnSe) or Clear Zinc Sulfide (MS-ZnS) will perform well because these infrared radiation material types have broad transmission across the infrared spectrum and do not degrade at high temperatures. In addition, the infrared radiation optical element 25 can be coated to selectively transmit a specific wavelength that is tuned to the peak performance of the TPV cell 11. If there is excess heat coming off the TPV cell 11, an energy conversion device (ECD) 29 can be added to improve efficiency of the tandem cell assembly. The ECD can be one of several options including but not limited to another TPV module, a fluid-based cooling system, or a thermoelectric generator. Adding the ECD, along with the PV and TPV cells will add efficiency to the Tandem Cell assembly. Adding the ECD also has the advantage of cooling and stabilizing the temperature of the TPV cell 11, giving it better operational efficiencies. Fluid transport hoses 31 can be used in the case that the ECD is a fluid-based system. Additional ECD units can be added to the bottom of the assembly if more heat energy is available.

The embodiment of FIG. 4 shows the tandem cell 8 with the PV cell 9 where the top layer of the PV material 15 has a backing layer of a highly emissive material 17. The infrared radiation 13 from the photovoltaic emissive surface 17 impinges on the TPV cell 11.

In the embodiment of FIG. 5, the tandem cell 8 with the PV cell 9 has a backing layer of a highly emissive material with surface-relief micro-structures 14 formed into the emissive surface to increase the infrared radiation emissivity, cool the photovoltaic cell 9 and to steer/focus the beam on to the TPV cell 11. As shown, the rays 13 emitted from the micro-structures 14 are focused to the center, thus concentrating the beam into a smaller spot size on the TPV cell 11. The TPV cell is smaller than the PV cell which reduces cost. The micro-structures can also be designed to emit a radiation wavelength that is tuned to the peak performance of the TPV cell 11.

FIG. 6 shows the tandem cell with the PV top surface formed 9 with anti-reflection nano-structures 22 to help capture maximum levels of incoming solar radiation. Also depicted are anti-reflection micro-structures on the TPV surface 23 to capture maximum levels of infrared radiation emitted from the PV cell. The height and period (spacing) of these conical shaped surface-relief structures are relative to the wavelength of light they are capturing and are trying to prevent from reflecting. For the incoming solar radiation at visible and shorter wavelengths the structures are called “nano-structures” as measured in nanometers. For the longer infrared wavelengths of light, the larger, wider spaced cones are called “micro-structures” as measured in micrometers. In the field of optics and photonics, thin-film coating layers have traditionally been used for anti-reflection (AR) surfaces. Advantages of the surface-relief anti-refection surfaces discussed above include high performance and a longer lifetime in high radiation environments than traditional AR thin film coatings; and, the surface-relief structures survive considerably longer than thin-film AR coatings and, the surface-relief structures survive considerably longer than thin-film AR coatings through intense thermal cycling as would be the environment of the tandem cell assembly. The cell has reflective walls 19 to direct stray, off normal angled light 21 onto the TPV surface.

The embodiment of FIG. 6A is similar to FIG. 6 but depicts the reflective cell walls as sloped 19 to help concentrate the stray light on to the TPV cell 11 and to properly mount a larger PV cell 9 to a smaller TPV cell 11.

The embodiment of FIG. 7 shows an internally reflective light pipe 25 through which the infrared radiation from the back of the TPV cell is channeled to another location where it can be directed in proportions by a Light Valve 27 to a thermal battery 28 or to an energy conversion device 29. In this case, a Winston concentrator type of mirror 24 is used to focus the light into the pipe, but other concentrator optical designs using lenses, mirrors or combinations thereof can be used to focus the radiation into the pipe. The thermal battery 28 can store the infrared radiation energy as heat and be released as desired/needed to the ECD 29 which can be helpful for electrical-grid peak load management. Optics within the pipe such as the mirror 26 can be used to guide the beam particularly around turns, bends, or corners.

FIG. 8A shows a tandem cell assembly 1, which can be mounted as part of a larger solar panel 30 that is made up of multiple tandem cell assemblies as in FIG. 8B. FIG. 8C shows the solar panel of FIG. 8B mounted with multiple such solar panels as part of a solar tracking platform/system.

The embodiment shown in FIG. 9 is similar to the embodiment shown in FIG. 7 with the exception that the infrared radiation from the photovoltaic cell 9 is directed to the light pipe that is received by the light pipe directly from the photovoltaic cell. The internally reflective light pipe 25 receives infrared radiation directly from the back of the PV cell 9 to channel the radiation to another location where it can be directed in proportion by a light valve 27 to a thermal battery 28 or to an energy conversion device 29. The TPV cell can be located at the end of the light pipe as an energy conversion device. A Winston concentrator type of mirror 24 focuses the radiation into the pipe. The thermal battery can store the infrared energy as heat and be released as desired or needed to the energy conversion device. Accordingly, this embodiment is particularly useful for electrical-grid peak load management. Optics within the pipe are used to guide the beam within the pipe. The embodiment of FIG. 9 has economic advantages in that individual TPV cells are not required to be mounted at each tandem cell assembly that is infrared radiation from multiple assemblies can be gathered and converted to electricity at a single location.

Inasmuch as the present invention is subject to many variations, modifications and changes in detail, it is intended that all subject matter discussed above or shown in the accompanying drawings be interpreted as illustrative only and not be taken in a limiting sense.

What is claimed is:

1. A tandem photovoltaic and thermophotovoltaic cell assembly for converting solar energy to electricity comprising a photovoltaic cell made of a material capable of converting light photons to electrons and having a top surface for exposure to concentrated sunlight and a back emissive surface for emitting heat from conversion of the concentrated light as infrared radiation; and
a thermophotovoltaic cell disposed at a position to receive the infrared radiation from the back emissive surface of the photovoltaic cell and made of a material capable of converting infrared radiation to electrons whereby said assembly produces electricity from both light and heat.

2. A system for conversion of solar energy to electricity comprising:
a housing;
a photovoltaic cell (PV) disposed in said housing and made of a material capable of converting photons to electrons, said photovoltaic cell having a top surface for receiving concentrated solar radiation and a bottom surface for emitting infrared radiation;
an optical system disposed in said housing to receive solar radiation and concentrate the solar radiation onto said top surface of said photovoltaic cell whereby said photovoltaic cell converts photons into electric current and is heated due to the concentrated radiation to emit infrared radiation from said bottom surface; and
a thermophotovoltaic cell (TPV) disposed in said housing to receive the infrared radiation from said photovoltaic cell, said thermophotovoltaic cell converting the infrared radiation to electric current.

3. The system recited in of claim 3 wherein said solar energy conversion system is highly efficient due to conversion of both light and heat to electricity and therefor helps to mitigate climate change by reducing and/or preventing additional greenhouse gas emissions.

4. A method of mitigating climate change by increasing the efficiency of conversion of solar energy to electricity comprising the steps of:
concentrating solar radiation onto a photovoltaic cell to produce electric current and infrared radiation to create heat due to the concentration of the solar radiation;
converting the infrared radiation to electric current with the use of a thermophotovoltaic cell; and
combining the light created electric current and the heat created electric current.
